(19) United States
(12) Patent Application Publication
(10) Pub. No.: US 2026/0268168 A1
(43) Pub. Date: Sep. 10, 2026

(54) PARALLEL FRAMEWORK FOR ACCELERATING COMBINATORIAL OPTIMIZATION

(71) Applicant: UNIVERSITY OF VIRGINIA PATENT FOUNDATION, Charlottesville, VA (US)

(72) Inventors: Nikhil Shukla, Crozet, VA (US); Nikhat Khan, Charlottesville, VA (US); Paul Orndorff, Palmyra, VA (US)

(21) Appl. No.: 19/556,758

(22) Filed: Mar. 4, 2026

Related U.S. Application Data
(60) Provisional application No. 63/766,702, filed on Mar. 4, 2025.

(51) Int. Cl. G06N 5/01; G06F 17/13

(52) U.S. Cl. CPC G06N 5/01; G06F 17/13

(57) ABSTRACT

A method for solving a combinatorial optimization problem includes receiving a spin network corresponding to the combinatorial optimization problem. The method further includes generating a plurality of replicas of the spin network. The method includes minimizing an energy of each replica of the plurality of replicas in parallel. The method includes resampling the plurality of replicas using a plurality of reweighting factors, wherein each reweighting factor of the plurality of reweighting factors corresponds to the energy of the replica. The method includes aggregating solutions produced by each replica of the plurality of replicas. The method further includes generating configurations based on the aggregated solutions.

### CROSS-REFERENCE TO RELATED APPLICATIONS

This application claims priority to U.S. Application No. 63/766,702, titled “PARALLEL FRAMEWORK FOR ACCELERATING COMBINATORIAL OPTIMIZATION”, filed Mar. 4, 2025, which is hereby incorporated by reference in its entirety.

### STATEMENT REGARDING FEDERALLY SPONSORED RESEARCH

This invention was made with government support under 2132918 awarded by the National Science Foundation. The government has certain rights in the invention.

### BACKGROUND

Combinatorial optimization problems involve determining configurations of discrete objects that satisfy given objectives. In particular, such problems arise in fields such as resource allocation, communication networks, artificial intelligence, and protein folding. Existing approaches to combinatorial optimization often struggle to balance solution quality with computational speed. Heuristic and meta-heuristic methods can provide approximate solutions relatively quickly, but may sacrifice accuracy for larger problem instances. Despite advances in various computational approaches, solving large-scale combinatorial optimization problems remains a challenge, as many existing methods struggle to simultaneously meet the accuracy and speed requirements for practical applications.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a method for solving a combinatorial optimization problem is provided. The method includes receiving a spin network corresponding to the combinatorial optimization problem. The method further includes generating a plurality of replicas of the spin network. The method includes minimizing an energy of each replica of the plurality of replicas in parallel. The method includes resampling the plurality of replicas using a plurality of reweighting factors, wherein each reweighting factor of the plurality of reweighting factors corresponds to the energy of the replica. The method includes aggregating solutions produced by each replica of the plurality of replicas. The method further includes generating configurations based on the aggregated solutions.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a system architecture for implementing a parallel combinatorial optimization system, according to some embodiments.

FIG. 2 illustrates a system architecture including computing device, server, data source, and communication network components, according to some embodiments.

FIG. 3 is a flow diagram illustrating an example process for performing combinatorial optimization, according to some embodiments.

FIG. 4 illustrates an example architectural framework depicting a multi-stage computational process, according to some embodiments.

FIG. 5 illustrates a schematic representation of a modified parallel combinatorial optimization system showing the evolution of replicas over multiple stages, according to some embodiments.

FIG. 6 illustrates a flowchart of a process of an example global resampling algorithm, according to some embodiments.

FIG. 7 illustrates an example chart showing benchmarking results comparing a modified parallel combinatorial optimization system against a conventional simulation bifurcation machine, according to some embodiments.

FIG. 8 illustrates charts showing solution differences between a modified parallel combinatorial optimization system and a simulated bifurcation machine, according to some embodiments.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

Described herein is a parallel combinatorial optimization system including a scalable technology for solving challenging combinatorial optimization problems (COPs). The parallel combinatorial optimization system integrates multi-level parallelism in the algorithm and may be implemented on parallelized hardware platforms to overcome accuracy versus speed trade-offs often encountered in solving large-scale COPs.

The parallel combinatorial optimization system may find applications across a wide range of industries and domains. In defense applications, the parallel combinatorial optimization system may be utilized for efficient allocation of resources, such as satellite resource allocation or optimal distribution of machinery and personnel. For communication applications, the parallel combinatorial optimization system may be applied to MIMO communication problems relevant to 5G and 6G standards. In the field of artificial intelligence, the parallel combinatorial optimization system may assist in training AI models such as Restricted Boltzmann Machines, which require iterative solutions to combinatorial optimization problems. Logistics applications may benefit from the parallel combinatorial optimization system's capabilities in route planning and scheduling optimization. The technology's ability to solve large-scale combinatorial optimization problems efficiently may make it suitable for addressing complex resource allocation challenges in various sectors. The parallel combinatorial optimization system's scalability and performance may enable it to tackle optimization problems that were previously computationally intractable. The technology's flexibility and reconfigurability may allow it to be customized for specific end-application needs across different industries.

Existing methods for solving combinatorial optimization problems use heuristics and metaheuristics; however, these methods cannot simultaneously meet the accuracy and speed metrics required for solving large scale combinatorial optimization problems. Heuristic and meta-heuristic methods can provide approximate solutions relatively quickly, but may sacrifice accuracy for larger problem instances, and many existing methods struggle to simultaneously meet the accuracy and speed requirements for practical applications. This presents a fundamental technical challenge: conventional computational approaches force a trade-off between solution quality and processing time, limiting the practical applicability of combinatorial optimization solvers for large-scale problems encountered in fields such as resource allocation, communication networks, and artificial intelligence.

The parallel combinatorial optimization system described in the present disclosure addresses this technical problem by exploiting engineered physics-inspired models that are efficient in exploiting the structure of the phase space, providing acceleration by embedding state-level parallelism, and integrating the physics-inspired models into a probabilistic framework that enables the system to explore the phase space through ensemble-level parallelism. As a non-limiting example, minimizing the energy of the replicas may simultaneously use engineered physics-inspired models, and this approach can exploit the structure of the phase space, providing acceleration through state-level parallelism. Each replica may be executed on a mathematically modeled dynamical system based on a network of coupled electronic oscillators, subjected to a second-harmonic injection locking signal. A Population Annealing Monte Carlo algorithm may be used, in which a population of independent system replicas is randomly initialized at a high initial temperature and then gradually cooled, and during each resampling step, low-energy replicas may be replicated multiple times, while high-energy replicas are preferentially eliminated from the population, in order to maintain a Gibbs-like energy distribution for the ensemble. To address the limitation that local spin-flip updates in Monte Carlo methods can become trapped in clusters of states separated by energy barriers that single-spin updates cannot efficiently overcome, the non-local moves strategy introduces collective updates by identifying iso-sites (i.e., spins for which the local field is balanced and whose flipping does not change the system energy) and from these iso-sites, a maximal independent set can be constructed, ensuring that no two selected spins are directly connected, enabling rapid traversal between otherwise disconnected regions of the configuration space.

The parallel combinatorial optimization system described in the present disclosure provides both speed and accuracy in solving large combinatorial optimization problems by overcoming the speed versus accuracy tradeoff through multi-level parallelism, and can exhibit improvements of various magnitudes (e.g., 10×) in time to compute compared to other state-of-the-art methods. The system is capable of delivering substantial accuracy gains, such as by achieving approximately a 6× reduction in cumulative solution error relative to a standalone modeled oscillator Ising machines. These improvements arise from the specific technical architecture that coordinates parallel replica evolution with energy-based resampling and adaptive temperature scheduling. The framework includes multiple stages, where each stage implements a parallel execution of replicas followed by a sequential post-processing step. This approach ensures that replicas in the subsequent stage are initialized not only with low-energy states, but also with configurations originating from diverse regions of the solution landscape, thereby promoting efficient exploration.

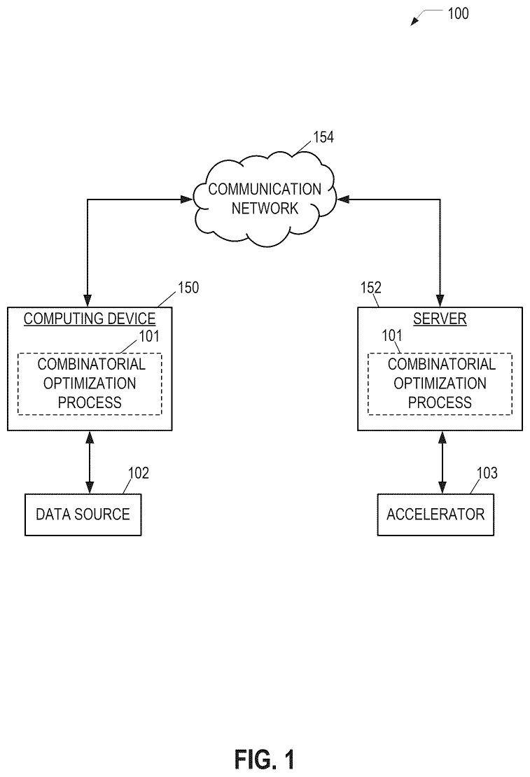

FIG. 1 illustrates a system architecture 100 for implementing the parallel combinatorial optimization system. System architecture 100 includes a computing device 150 and a server 152 connected through a communication network 154. Computing device 150 and server 152 may cooperate to perform a combinatorial optimization process 101. A data source 102 may provide input data to computing device 150 for processing the combinatorial optimization process 101.

The server 152 may also store a combinatorial optimization process 101 and may be connected to an accelerator 103. The accelerator 103 may provide computational acceleration capabilities to enhance the processing performed by combinatorial optimization process 101 on server 152. In some cases, accelerator 103 may be an Ising machine, such as an analog oscillator Ising machine. Examples of accelerator 103 may include accelerators based on magnetic devices, optics, memristors, spin switches, quantum dots, single atoms, microdroplets, or Bose-Einstein condensates.

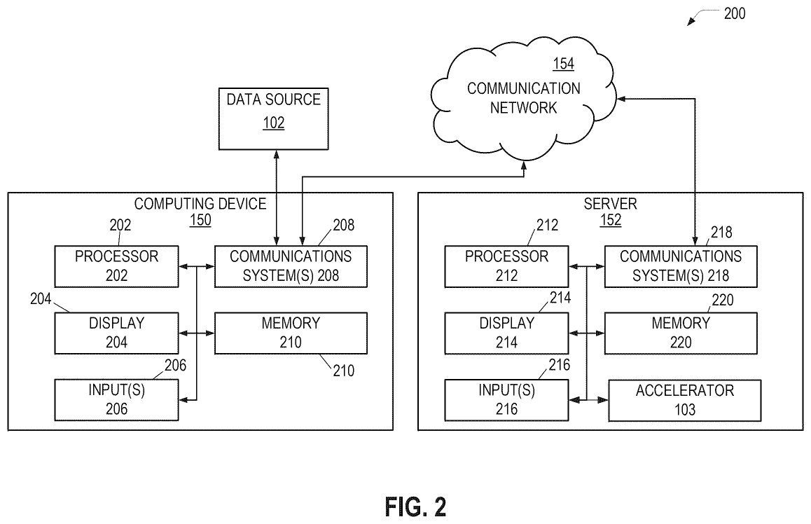

FIG. 2 illustrates a system architecture 200 that includes computing device 150, server 152, data source 102, and communication network 154 interconnecting these components.

The computing device 150 includes a client processor 202 coupled to multiple components including a client display 204, client input 206, a client communication system 208, and client memory 210. Client processor 202 may coordinate the operation of these components, with client display 204 providing visual output, client input 206 accepting user commands, and client communication system 208 enabling network connectivity. Client memory 210 may store data and instructions for operation.

The server 152 comprises a server processor 212 connected to various components including a server display 214, server input 216, server communication system 218, server memory 220, and accelerator 103. Server processor 212 may manage server operations, while server display 214 provides visual output and server input 216 accepts input commands. Server communication system 218 may facilitate network connectivity, and server memory 220 may store data and instructions. The accelerator 103 may provide additional processing capabilities. For example, an oscillator-based Ising machine may be an implementation of accelerator 103.

The data source 102 connects to both computing device 150 and communication network 154. The communication network 154 may enable data exchange between computing device 150 and server 152, allowing for distributed processing and data transfer between components of system architecture 100. The communication network 154 may include a Wi-Fi network (including wireless routers, switches), a peer-to-peer network (e.g., Bluetooth), a cellular network (3G, 4G, complying with standards such as CDMA, GSM, LTE, LTE Advanced, WiMAX), other types of wireless networks, a wired network, a local area network, a wide area network, a public network (e.g., the Internet), or a private or semi-private network (e.g., corporate or university intranet).

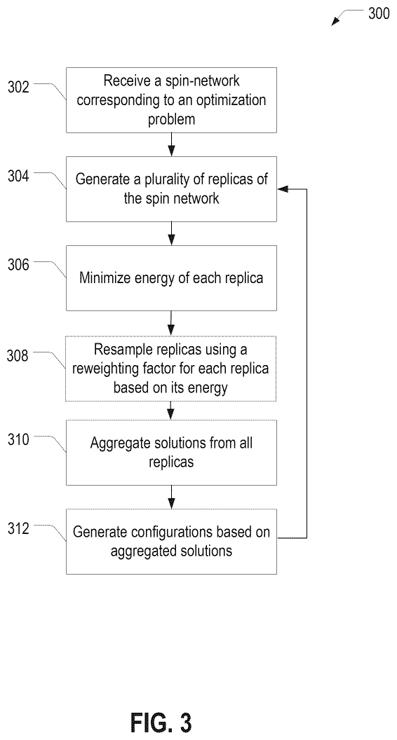

In some cases, server 152 may implement the systems and may use accelerator 103 to implement the systems and perform the processes described below. For example, server processor 212 may execute instructions stored in server memory 220 to implement the multi-stage computational process illustrated in FIG. 3, with accelerator 103 providing additional processing power for parallel computations.

The computing device 150 may serve as a user interface for interacting with the parallel combinatorial optimization system. In some cases, client processor 202 may execute instructions stored in client memory 210 to display user interface elements on client display 204, allowing users to input problem data and configuration parameters through client input 206. This input may be transmitted to server 152 via client communication system 208 and communication network 154.

The server 152 may process the received data using the parallel combinatorial optimization system. In some cases, server processor 212 may coordinate with accelerator 103 to perform parallel annealing processes as described in relation to process 300, described below. The results of these computations may be stored in server memory 220 and transmitted back to computing device 150 for display to the user.

In some cases, the system architecture 100 may implement a distributed processing approach where computational tasks are divided between computing device 150 and server 152. For example, computing device 150 may handle user interface and data preparation tasks, while server 152 performs the more computationally intensive optimization processes using accelerator 103. The computing device 150 and server 152 may be implemented as a desktop computer, laptop computer, tablet computer, server computer, or virtual machine being executed by a physical computing device. The data source 102 may include a vendor, third-party, internal datastore, or data synthesizer.

The components of system architecture 100 may work together to implement the parallel combinatorial optimization system, combining the user interface capabilities of computing device 150 with the processing power of server 152 and accelerator 103 to solve complex combinatorial optimization problems efficiently.

FIG. 3 is a flow diagram illustrating an example process 300 for performing combinatorial optimization, according to some embodiments. As described below, a particular implementation can omit some or all illustrated features/steps, may be implemented in some embodiments in a different order, and may not require some illustrated features to implement all embodiments. In some examples, an apparatus (e.g., computing device 150, server 152, processor 202, processor 212, etc.) in connection with FIGS. 1 and 2 (described above) can be used to perform example process 300. In some examples, process 300 may correspond to the combinatorial optimization process 101 described above. However, it should be appreciated that any suitable apparatus or means for carrying out the operations or features described below may perform process 300.

At operation 302, a spin-network corresponding to an optimization problem is received. In some examples, the spin network may be configured as a graph with edges or lines that represent a “unit.” The spin-network may represent multilinear functions between different “units.”

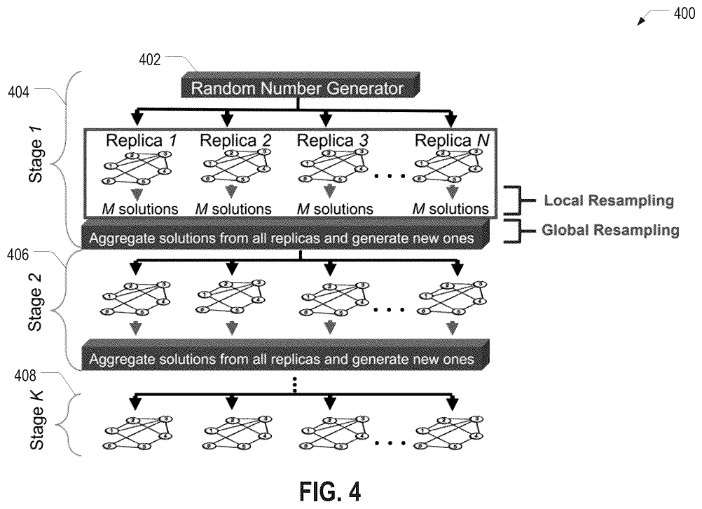

At operation 304, a plurality of replicas of the spin network are generated. In some examples, each replica N may represent a mutation of a problem instance that is initialized randomly. FIG. 4 illustrates an example architectural framework 400 depicting a multi-stage computational process associated with process 300. As illustrated in FIG. 4, the plurality of replicas of the spin network may be generated using a random number generator 402. For example, the random number generator 402 may generate inputs for multiple replicas, labeled as Replica 1 through Replica N. Each replica may represent a spin network configuration that produces M solutions.

At operation 306, the energy of each replica is minimized. In some examples, minimizing the energy (e.g., the Hamiltonian) of the replicas may simultaneously use engineered physics-inspired models. This approach can exploit the structure of the phase space, providing acceleration through state-level parallelism. For example, each replica may be executed on a mathematically modeled dynamical system based on a network of coupled electronic oscillators, subjected to a second-harmonic injection locking (SHIL) signal, whose dynamics can be described by:

$$\frac{d {ϕ}_{i} ( t )}{dt} = - K {\sum }_{{j = 1}_{j \neq i}}^{n} {J}_{i j} sin ( {ϕ}_{i} ( t ) - {ϕ}_{j} ( t ) ) - {K}_{s} sin ( 2 {ϕ}_{i} ( t ) ) \qquad ( 1 )$$

where K denotes the coupling strength of the oscillator network, Kₛ represents the strength of the SHIL signal, and Jᵢⱼ encodes the connectivity of the network.

At operation 308, replicas are resampled using a reweighting factor that is calculated for each replica based on its energy. In some examples, a Population Annealing Monte Carlo (PAMC) algorithm may be used, in which a population of R independent system replicas is randomly initialized at a high initial temperature and then gradually cooled. For example, operation 308 may be carried out by computing a reweighting factor for each replica based on its energy. During each resampling step, low-energy replicas may be replicated multiple times, while high-energy replicas are preferentially eliminated from the population, in order to maintain a Gibbs-like energy distribution for the ensemble.

Specifically, the reweighting factor for a replica j with energy Eⱼ is given by exp(−ΔβEⱼ), where Δβ=βᵢ₊₁−βᵢ. The expected number of copies of replica j after resampling is expressed as

$${τ}_{j} ( {β}_{i} , {β}_{i + 1} ) = \frac{{e}^{- ( {β}_{i + 1} - {β}_{i} ) {E}_{j}}}{Q ( {β}_{i} , {β}_{i + 1} )}$$

where Q(βᵢ,βᵢ₊₁) is a normalization factor, defined as

$$Q ( {β}_{i} , {β}_{i + 1} ) = \frac{1}{R} {\sum }_{j = 1}^{R} {e}^{- ( {β}_{i + 1} - {β}_{i} ) {E}_{j}} .$$

Following resampling, replicas may become highly correlated. To decorrelate them, each replica may undergo a fixed number of Monte Carlo sweeps using a stochastic local spin-update rule equivalent to the heat-bath (Glauber) Gibbs sampler. This update rule is mathematically equivalent to the stochastic activation employed in p-bit neurons, where the output state fluctuates probabilistically according to its input bias. For a spin configuration s and site k, the local effective field is hₖ=ΣⱼJₖⱼsⱼ and the spin is updated according to: sₖ←sgn[tanh(βhₖ)−(2r−1)], r~U(0,1). In some examples, during each Monte Carlo sweep, all spins may be updated once in a randomized sequential order, ensuring unbiased sampling of the configuration space. This update process is executed in parallel across replicas. At the end of these sweeps, a new set of configurations—one per replica—is obtained and used as the initial condition for the subsequent stage.

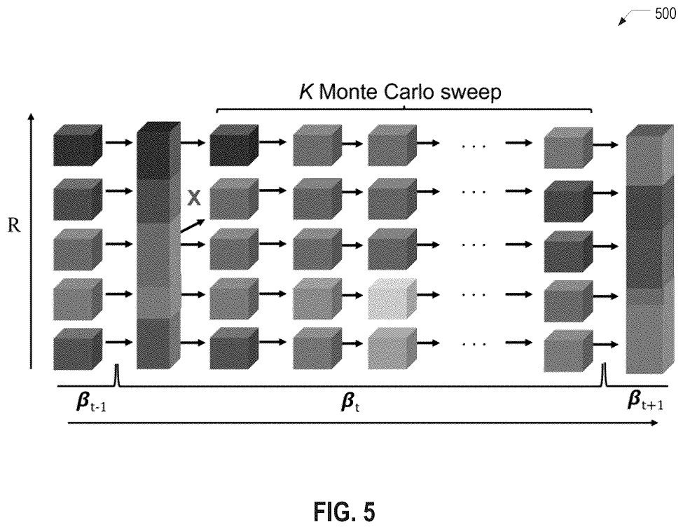

FIG. 5 illustrates a schematic representation 500 of a modified parallel combinatorial optimization system, illustrating the evolution of R replicas over multiple stages. βₜ denotes the inverse temperature at stage t, and at each temperature stage, K Monte Carlo (MC) sweeps may be performed.

At operation 310, solutions produced by each replica are aggregated. In some examples, aggregation of solutions may include parallel computations performed, where each replica independently evolves to find lower-energy configurations. This may be performed using physics-inspired computational models such as Ising machines or oscillator dynamics. In some examples, the Ising machine may include a digital or analog Ising machine, such as an analog or digital oscillator Ising machine. In some cases, the Ising machine may be implemented via a graphical processing unit (GPU) executing instructions stored on a non-transitory computer readable medium, a digital application-specific integrated circuit (ASIC) such as an accelerator circuit, or other implementations including Ising machine systems based on magnetic devices, optics, memristors, spin switches, quantum dots, single atoms, microdroplets, or Bose-Einstein condensates.

At operation 312, configurations are generated based on the aggregated solutions. In some examples, each replica may undergo a dynamical evolution in parallel, starting from time to and evolving until tₛₜₒₚ with a time step Δt. This results in a total number of iterations numitr=tₛₜₒₚ/Δt, producing a new modified configuration (solution) at each iteration. The cut value corresponding to each configuration is computed at every iteration, where maximizing the cut value is equivalent to minimizing the system energy. In other words, each replica traverses a sequence of configurations—equal in number to the total iterations—and their corresponding energy values are evaluated at operation 312.

In some examples, within each replica, rather than retaining the full trajectory of configurations, only a fixed M number of low-energy configurations are aggregated. These configurations represent the most promising solutions discovered by that replica and constitute a local resampling process. During this process, the energy of each newly generated configuration is compared against those already stored, ensuring that only low-energy configurations are retained. Once the top M configurations from each of the N replicas are identified, the parallel execution is paused. All M×N configurations may then be collected into a single global matrix and sorted in ascending order of energy. From this sorted set, only the top unique low-energy configurations (equal in number to the total replicas) may be propagated to the next stage as initial conditions. The remaining higher-energy configurations are discarded. This post-processing step may be executed sequentially. As described further below, in some examples, this post-processing step may include global resampling. In some examples, the framework may include multiple stages, where each stage includes parallel execution of replicas followed by a sequential post-processing step. This approach ensures that replicas in the subsequent stage are initialized not only with low-energy states but also with configurations originating from diverse regions of the solution landscape, thereby promoting efficient exploration.

In some examples, low-energy solutions encountered across different replicas may possess identical energy values while corresponding to distinct spin configurations, characterized by non-zero Hamming distances. Such configurations are referred to as iso-energy configurations, as they occupy different regions of the solution space despite sharing the same energy. To avoid redundant replication of identical configurations, only iso-energy configurations with non-zero Hamming distances are preserved. Additionally, to enable a consistent comparison, each new configuration is forced onto the same reference plane as the configuration it is being compared against. This is achieved by using the first spin as a reference and, if necessary, flipping the entire configuration (by multiplying all spins by −1) to align the first spin.

In some examples, the operations 304-310 illustrated in process 300 may be repeated. For example, as illustrated in FIG. 4, replicas may be processed through multiple stages. In particular, each stage may represent a repetition of operations 304-310 of process 300. For example, in stage 1 404, the energy of the spin-network replicas is minimized in parallel. All replicas may be aggregate and new ones may be generated (corresponding to operations 308 and 310 of process 300), which are then fed into stage 2 406.

At stage 2 406, the energy of the spin-network replicas is again minimized in parallel. Another aggregation of solutions from all replicas is performed and new configurations are generated for subsequent processing. This pattern continues through multiple iterations, ultimately reaching a stage k 408, which, upon completion, creates configurations that are implemented. In some examples, k may represent a predefined number of stages that are to be completed. In further examples, k may represent an iteration in which a convergence is detected based on population statistics. After a number of annealing rounds, the lowest energy configurations may be output, or their energies may be compared and the lowest energy configuration overall may be selected and output as the solution to the combinatorial optimization problem.

In some examples, the dynamics within the replicas can be simulated using a stochastic differential equation (SDE) solver that introduces noise into the system. This stochasticity enables the dynamics to escape local minima (sub-optimal solutions) in the high-dimensional phase space, thereby improving solution quality with minimal performance overhead. Accordingly, the dynamics may be expressed as dP=g(⋅)dt+AₙdWₜ where dWₜ denotes a Wiener process that introduces stochastic perturbations, Aₙ is the noise amplitude, and g(⋅) corresponds to the right-hand side of Eq. (1). In some examples, the noise amplitude may depend on the simulated temperature, with higher temperatures corresponding to larger noise amplitudes to facilitate broader exploration of the phase space. In addition, a tanh(⋅) nonlinearity may be employed to augment the phase dynamics. In some examples, the numerical integration is performed using a fourth-order Runge-Kutta (RK4) method, with noise injected at each stage.

Beyond the process 300 described above, two additional strategies may be incorporated to introduce controlled randomness and to balance exploration with local refinement. First, non-local moves may be implemented. In some examples, local spin-flip updates in Monte Carlo methods may be a limitation in which the parallel combinatorial optimization system can become trapped in clusters of states separated by energy barriers that single-spin updates cannot efficiently overcome. To address this issue, the non-local moves strategy introduces collective updates by identifying iso-sites (i.e., spins for which the local field is exactly balanced and whose flipping does not change the system energy). From these iso-sites, a maximal independent set (MIS) may be constructed, ensuring that no two selected spins are directly connected. Because such moves preserve the system energy, they may enable rapid traversal between otherwise disconnected regions of the configuration space.

Moreover, an adaptive temperature schedule may be implemented. Rather than predefining the entire temperature schedule, the inverse temperature may be dynamically adjusted based on observed population statistics, such as stagnation in the maximum cut value or reduced diversity within the ensemble. When progress stalls, β may be decreased to reintroduce exploration, whereas continued improvements allow the temperature schedule to proceed with increasing β. In some example, one or more of these strategies may be activated when the parallel combinatorial optimization system exhibits stagnation due to entrapment in local minima. Together, these improvements may enable the algorithm to maintain a more effective balance between local refinement and global exploration, thereby improving convergence to high-quality solutions.

In some embodiments, a hybrid solver approach may be implemented. The oscillator dynamics-based system may provide state-level parallelism, enabling rapid convergence to near-optimal solutions, while the Monte Carlo-based approach may implement sequential spin updates. In some cases, both methodologies may be integrated into a unified solver. In such a hybrid approach, the system may first exploit oscillator dynamics to quickly reach a high-quality solution, after which the resulting configurations may be passed to the metaheuristic framework. The metaheuristic framework may then facilitate escape from local minima and guide the system toward convergence to the best solution or global minimum.

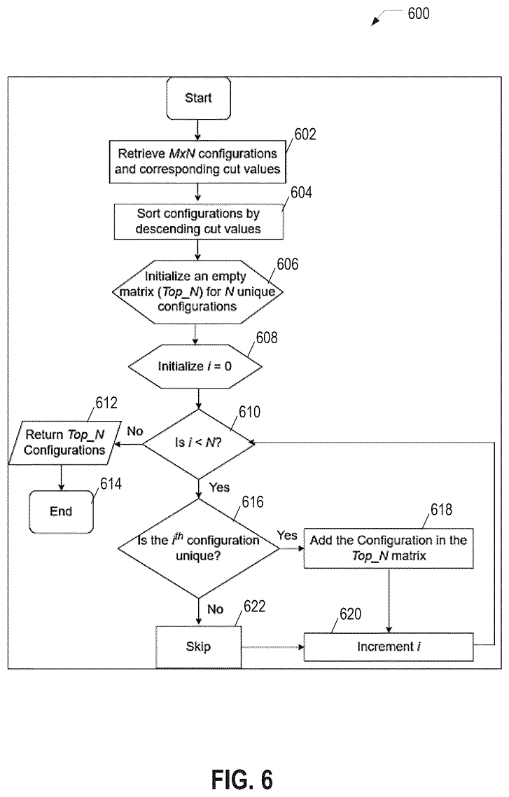

FIG. 6 illustrates a flowchart of a process 600 of as example global resampling algorithm. At operation 602, M×N configurations and corresponding cut values are received. At operation 604, the configurations are sorted, for example by descending cut values, ascending energy values, etc. At operation 606, an empty matrix (Top_N) is initialized for N unique configurations. At operation 608, the current iteration is initialized to zero.

At operation 610, the process 600 determines if the current iteration is less than N. If the check performed at operation 610 determines that the current iteration is not less than N, the process 600 proceeds to operation 612, the Top_N configurations are returned, followed by operation 614, where the process 600 ends. If the check performed at operation 610 determines that the current iteration is less than N, the process 600 moves to operation 616 to determine if the configuration for the current iteration is unique.

If the configuration is unique, the process 600 proceeds to operation 618, where the configuration is added to the Top_N matrix. If the configuration is not determined as being unique at operation 616, the process 600 moves to operation 620 to skip the current configuration. After either operation 618 or operation 620 has been completed, the process 600 proceeds to increment the iteration counter. As illustrated in FIG. 6, the process 600 then loops back to operation 610 to continue processing configurations. In some examples, the resampling algorithm process 600 repeats until predefined conditions are met. This iterative approach, combined with the multi-level parallelism, allows the parallel combinatorial optimization system to efficiently explore the solution space while maintaining solution quality.

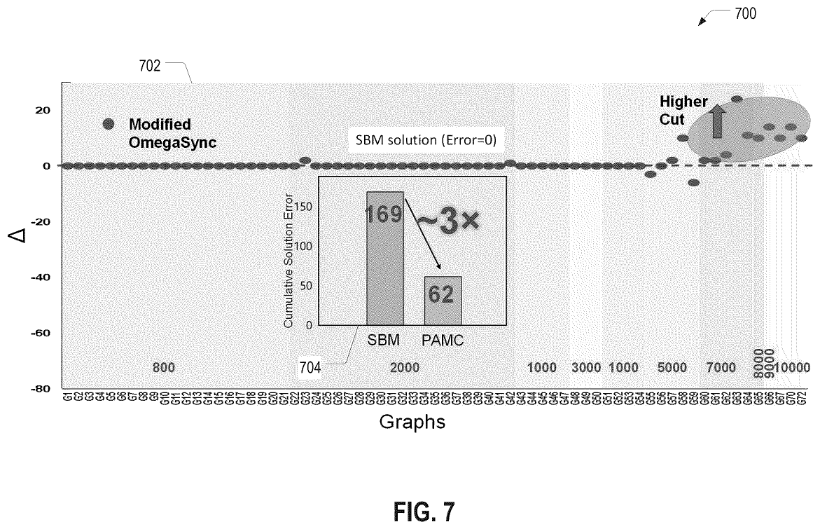

The inventors performed benchmarking of the modified parallel combinatorial optimization system described herein. FIG. 7 illustrates an example chart 700 showing results of the benchmarking. In particular, section 702 corresponds to solutions achieved across a G-set benchmark using the modified parallel combinatorial optimization system. The metric A of the y-axis represents the difference between a conventional simulation bifurcation machine (SBM) and the modified parallel combinatorial optimization system. Section 704 corresponds to a cumulative solution error, defined as the sum of the minimum solution error across all G-set instances.

The G-set consists of 71 Max-Cut benchmark instances (G1 to G81), ranging from 800 to 20,000 vertices and from a few thousand to approximately 40,000 edges. These graphs primarily exhibit three structural classes: random, planar, and toroidal. The dataset includes both unipolar (all+1) and bipolar (±1) edge weights. Since several large instances still lack proven optimal solutions and best-known cut values continue to improve, the G-set remains an active and widely used benchmark for evaluating new solvers.

Algorithm 1: Modified Parallel Combinatorial Optimization System with Adaptive Temperature and Non-Local Moves:
Input: Adjacency (coupling) matrix J; population size R; number of Monte Carlo (MC) sweeps S; target cut MC*; reset threshold Tᵣₛₜ; base inverse temperature β₀; inverse temperature step Δβ; number of top configurations n.

Output: Best cut value found.

| | |
|---|---|
| 1 | Initialization: Generate an initial population P of random |
| | configurations; |
| 2 | Sort configurations by cut value and retain the best R replicas; |
| 3 | set z ← 1, β ← β₀; |
| 4 | Initialize best-so-far cut M* ← 0; |
| 5 | while M* < MC* do |
| 6 | if z > 1 then |
| 7 | Resample the population P using current energies and Δβ; |
| 8 | if progress stalls then |
| 9 | Apply non-local moves to the top n configurations; |
| 10 | Pause further non-local moves for a fixed number of steps; |
| 11 | Run Monte Carloupdates on P at inverse temperature β for S |
| | sweeps; |
| 12 | Compute cut values for all updated replicas; |
| 13 | Update M* ← max(M*, maxCut(P) |
| 14 | Adapt the inverse temperature β for next stage z; |
| 15 | if z ≥ Tᵣₛₜ then |
| 16 | Reset the temperature schedule: β ← β₀ |
| 17 | z ← 1; |
| 18 | else |
| 19 | z ← z+1; |
| 20 | β ← β+Δβ; |
| 21 | return M* |

The modified parallel combinatorial optimization system was implemented on a GPU using CUDA, along with the Thrust and cuBLAS libraries. The full modified parallel combinatorial optimization system framework, including non-local moves and adaptive temperature scheduling, was mapped to GPU kernels and executed on an NVIDIA RTX A6000 GPU within the UVA HPC cluster. Both the original parallel combinatorial optimization system and the modified parallel combinatorial optimization system were benchmarked against the conventional SBM, which leverages the dynamics of a Kerr Parametric oscillator network.

Two performance metrics are used to assess solver performance: Time-to-solution (TTS) and solution quality. The TTS is defined as the expected time required to reach a particular target solution with 99% probability and is given by

$$T T S = T \cdot \frac{log ( 1 - 0.99 )}{log ( 1 - {P}_{s} )} ,$$

where T denotes the total runtime of a single run and Ps is the empirical success probability.

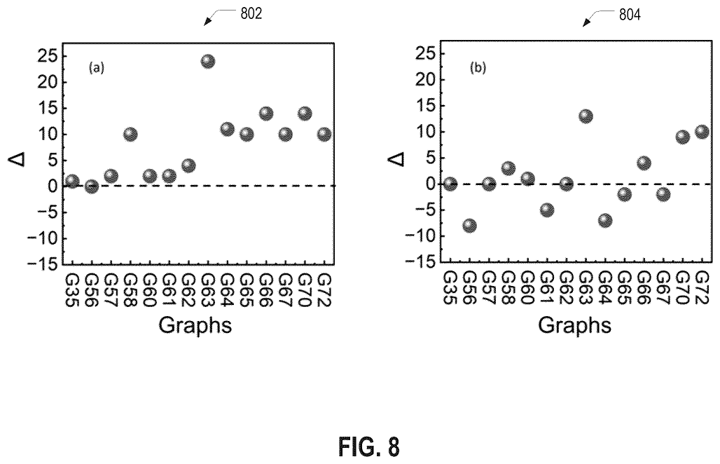

FIG. 8 illustrates a solution difference (Δ) between the solutions obtained by the modified parallel combinatorial optimization system and SBM. A positive Δ indicates an improvement over SBM, while a negative A indicates underperformance relative to SBM. The plots include only those G-set instances for which SBM reported a TTS exceeding 5000 seconds. For each such graph, the modified parallel combinatorial optimization system was executed for 10 independent runs, each with a wall-clock time equal to SBM's reported TTS.

As shown in chart 802 of FIG. 8, 13 out of 14 graphs yielded improved solutions than SBM when considering the best solution achieved across the 10 runs. When considering the worst solution across the 10 runs, improvements were observed for 6 graphs, as shown in chart 804.

In some cases, the modified parallel combinatorial optimization system may be able to identify new ground states for benchmark instances. For instance, in an example study the modified parallel combinatorial optimization system was able to identify a new ground state for instance G63 (i.e., one of the G-set graphs with a high edge count) nearly a decade after the last reported improvement. This demonstrates the capability of the modified parallel combinatorial optimization system to discover improved solutions for challenging problem instances that have resisted improvement by other solvers.

A number of implementations have been described. Nevertheless, it will be understood that various modifications may be made without departing from the spirit and scope of the disclosure. Accordingly, other implementations are within the scope of the following claims.

1. A method for solving a combinatorial optimization problem, the method comprising:
receiving a spin network corresponding to the combinatorial optimization problem;
generating a plurality of replicas of the spin network;
minimizing an energy of each replica of the plurality of replicas in parallel;
resampling the plurality of replicas using a plurality of reweighting factor, wherein each reweighting factor of the plurality of reweighting factors corresponds to the energy of the replica;
aggregating solutions produced by each replica of the plurality of replicas; and
generating configurations based on the aggregated solutions.

2. The method of claim 1, wherein resampling the plurality of replicas comprises:
replicating low-energy replicas; and
eliminating high-energy replicas.

3. The method of claim 1, wherein aggregating solutions comprises:
collecting configurations from each replica into a global matrix;
sorting the configurations in ascending order of energy; and
selecting low-energy configurations for propagation.

4. The method of claim 3, wherein the low-energy configurations comprise iso-energy configurations with non-zero Hamming distances.

5. The method of claim 1, further comprising repeating the minimizing, resampling, aggregating, and generating until a predefined condition is met.

6. The method of claim 5, wherein the predefined condition comprises at least one of: a target solution quality, a predefined number of stages, a fixed runtime limit, or a detected convergence.

7. The method of claim 5, further comprising outputting a lowest energy configuration as a solution to the combinatorial optimization problem after a number of annealing rounds.

8. The method of claim 1, further comprising dynamically adjusting an inverse temperature based on observed population statistics, wherein the population statistics include at least one of a maximum cut value or a diversity value.

9. The method of claim 8, wherein dynamically adjusting the inverse temperature comprises at least one of:
decreasing the inverse temperature; or
increasing the inverse temperature.

10. The method of claim 1, wherein minimizing the energy of each replica comprises executing each replica on a dynamical system based on a network of coupled electronic oscillators subjected to a second-harmonic injection locking (SHIL) signal.

11. The method of claim 1, wherein the method is implemented using an Ising machine, wherein the Ising machine comprises at least one of:
a digital oscillator Ising machine,
an analog oscillator Ising machine,
a graphical processing unit (GPU) executing instructions stored on a non-transitory computer readable medium,
a digital application-specific integrated circuit (ASIC), or
an Ising machine system based on magnetic devices, optics, memristors, spin switches, quantum dots, single atoms, microdroplets, or Bose-Einstein condensates.

12. The method of claim 1, wherein minimizing the energy of each replica comprises simulating dynamics using a stochastic differential equation (SDE) solver that introduces noise into the system via a Wiener process.

13. The method of claim 1, further comprising decorrelating the plurality of replicas after resampling by performing a fixed number of Monte Carlo sweeps using a stochastic local spin-update rule.

14. The method of claim 1, further comprising implementing non-local moves by identifying iso-sites comprising spins for which a local field is exactly balanced, and constructing a maximal independent set (MIS) from the iso-sites.

15. The method of claim 1, further comprising aligning configurations by using a first spin as a reference and flipping an entire configuration by multiplying all spins by negative one to align the first spin.

16. The method of claim 1, further comprising implementing a hybrid solver that combines an oscillator dynamics-based system providing state-level parallelism with a Monte Carlo-based approach implementing sequential spin updates.

17. The method of claim 1, wherein the method is implemented on a graphical processing unit (GPU) using parallel computing libraries.
